(19) United States
(12) Patent Application Publication
(10) Pub. No.: US 2025/0018855 A1
(43) Pub. Date: Jan. 16, 2025

(54) RECREATION VEHICLE AND TOWING SAFETY SYSTEM

(71) Applicant: Brandmotion, Novi, MI (US)

(72) Inventors: John F. Varick, Ann Arbor, MI (US); Jimmy McWherter, Macomb Township, MI (US); Austin Rivera, Waterford, MI (US); Joseph Nieman, Waterford, MI (US); Roman Dalfonsi, Dearborn, MI (US)

(73) Assignee: Brandmotion, Novi, MI (US)

(21) Appl. No.: 18/772,449

(22) Filed: Jul. 15, 2024

Related U.S. Application Data
(60) Provisional application No. 63/513,654, filed on Jul. 14, 2023.
(60) Provisional application No. 63/513,656, filed on Jul. 14, 2023.
(60) Provisional application No. 63/513,653, filed on Jul. 14, 2023.
(60) Provisional application No. 63/584,621, filed on Sep. 22, 2023.

(51) Int. Cl. B60Q 1/00; B60Q 1/26; B60Q 1/32; B60R 1/26

(52) U.S. Cl. CPC B60Q 1/0023; B60Q 1/2615; B60Q 1/32; B60R 1/26

(57) ABSTRACT

An integrated towing safety system configured to avoid compatibility issues, enable a driver to personally select video camera placement, and/or provide an aesthetically pleasing camera installation. The integrated towing system may combine the functionality of a side marker light with a wireless camera so as to provide blind spot awareness without unduly compromising vehicle aesthetics and/or without requiring extensive modifications and/or expensive or complex installation.

### RELATED APPLICATION

This application claims the benefit of U.S. provisional application No. 63/513,653, filed Jul. 14, 2023, U.S. provisional application No. 63/513,654, filed Jul. 14, 2023, U.S. provisional application No. 63/513,656, filed Jul. 14, 2023, and U.S. provisional application No. 63/584,621, filed Sep. 22, 2023, the disclosures of which are hereby incorporated by reference in their entireties herein.

### INTRODUCTION

The present disclosure relates to towing safety systems, such as but not necessarily limited to aftermarket towing safety systems configured for supporting wireless transmission of video images between a wireless camera attached to a recreation vehicle (RV), trailer, or other towed vehicle and a receiver, display, monitor, etc. inside of a tow vehicle.

When trailering, towing, and the like, a driver or another occupant of tow vehicle may experience difficulties viewing certain areas around a tow vehicle and/or a towed vehicle. Some of these difficult to view areas may result from the size, shape, etc. of the towed vehicle blocking or otherwise obstructing the driver's field of view to the extent the driver may be prevented from effectively observing areas around the tow and/or towed vehicles, with those areas generally being referred to as blind spots. Such blinds spots may present safety challenges during lane changes, merging, turning maneuvers, parking, backing up, and/or while otherwise operating the tow and/or towed vehicles.

Some towed vehicles may be manufactured with pre-installed video cameras configured to capture video images from pre-selected blind spots around the tow and/or towed vehicles. The captured video images may be communicated to a display inside of the tow vehicle for driver review. The inclusion of video cameras at the time of manufacture, however, may present compatibility challenges as a result of difficulties attendant to assessing where and how the pre-installed video cameras may be needed, e.g., the blind spots may vary from driver to driver, difficulties in predicting capabilities of a tow vehicle to interact with the pre-installed video cameras, e.g., there may be a wide variety of protocols, standards, etc. that may limit an ability of pre-installed video cameras to effectively communicate with differing display systems inside of differing tow vehicles, and/or for a wide variety of other reasons associated with pre-installing video cameras prior to understanding the end user and/or the tow vehicle.

To ameliorate some of the difficulties associated with pre-installed video cameras, some towed vehicles may be retrofitted after manufacture to include an aftermarket video camera. Such aftermarket installations, however, may also present difficulties due to the cost and/or complexity of having to attach a video camera and/or other supporting equipment and componentry to a towed vehicle, e.g., some owners may lack the requisite technical skills to properly fasten, seal, electrically connect, and/or otherwise perform the tasks needed to install a video camera system and/or in the alternative it may be expensive to hire a professional to do so. Additionally, it may be challenging to install aftermarket video cameras in an aesthetically pleasing and/or reliable manner, e.g., antennas and other componentry may create an unappealing aesthetic and/or the video camera may be installed in exposed positions such that the components, antennas, lens, etc. may become unreliable due to damage, excessive wear, etc.

### SUMMARY

One aspect of the present disclosure relates to an integrated towing safety system configured to avoid compatibility issues, enable a driver to personally select video camera placement, and/or provide an aesthetically pleasing camera installation. The integrated towing system may be installed at the time of manufacture and/or thereafter as an aftermarket or a retrofitted system. The system may combine the functionality of a side marker light with a wireless camera so as to provide blind spot awareness without unduly compromising vehicle aesthetics and/or without requiring extensive modifications and/or expensive or complex installation.

One aspect of the contemplated safety system may include an integrated mount configured for mounting both a side marker light and a wireless camera. The integrated mount may include a camera portion for retaining the wireless camera and a side marker portion for retaining the side marker light in such a way that the integrated mount may be attached to the towed vehicle by simply removing an existing side marker light, inserting the side marker light and the wireless camera into the integrated mount, and thereafter fastening the integrated mount to the location previously used for the original side marker light. The integrated mount may optionally be configured to leverage use of fasteners, supports, electrical connections, drill holes, etc. employed to attach the side marker light at the time of manufacture. In this manner, the integrated mount may optionally be attached to the towed vehicle without having to drill additional holes and/or otherwise undertake complex installation, while at the same time optionally minimizing costs by enabling re-use of a previously installed, side marker light.

One aspect of the present disclosure relates to an integrated side marker light and wireless camera unit. The system may include a side marker light including a light source and a light lens, optionally with the light source configured for emitting light towards the light lens and the light lens configured for dispersing the light to illuminate an ambient area. The system may further include a camera including a camera lens and a wireless transmitter, optionally with the camera lens configured for generating video images and the wireless transmitter configured for wirelessly transmitting the video images to a wireless receiver of a tow vehicle. The system may include an integrated mount configured for retaining the side marker light and the camera to an exterior surface of a towed vehicle, wherein the integrated mount includes a side marker portion configured for retaining the side marker light and a camera portion configured for retaining the camera, optionally with the side marker portion and the camera portion configured to vertically orientate the camera relative to the side marker light such that a rearward camera end of the camera is flush with or forward of a rearward marker end of the side marker portion.

One aspect of the present disclosure relates to an integrated mount configured for attaching a side marker light and a wireless camera to an exterior surface of a towed vehicle with a plurality of fasteners. The mount may include a camera portion configured for retaining the wireless camera, optionally with the wireless camera including a camera lens configured for generating video images and a wireless transmitter configured for wirelessly transmitting the video images to a wireless receiver of a tow vehicle. The mount may include a side marker portion configured for retaining the side marker light, optionally with the side marker light including a light source configured for emitting light, a light lens configured for dispersing the light to illuminate an ambient area, and a light source frame including a plurality of apertures configured for receiving a corresponding one of the fasteners. The side marker portion may include a plurality of through-holes, optionally with each through-hole being aligned with one of the apertures to permit the fastener received therein to pass through the side marker portion to the exterior surface. The side marker portion and the camera portion may be configured to vertically orientate the wireless camera relative to the side marker light such that a rearward camera end of the wireless camera is flush with or forward of a rearward marker end of the side marker portion.

One aspect of the present disclosure relates to an integrated towing system. The towing system may include a side marker light having a light source and a light lens, optionally with the light source configured for emitting light towards the light lens and the light lens configured for dispersing the light to illuminate an ambient area. The towing system may include a camera having a camera lens and a wireless transmitter, optionally with the camera lens configured for generating video images and the wireless transmitter configured for wirelessly transmitting the video images. The towing system may include a wireless receiver configured for use in a tow vehicle to wirelessly receive and display the video images. The towing system may include an integrated mount configured for retaining the side marker light and the camera, optionally with the integrated mount including a side marker portion configured for retaining the side marker light and a camera portion configured for retaining the camera. The side marker portion and the camera portion may be configured to vertically orientate the camera relative to the side marker light such that a rearward camera end of the camera is flush with or forward of a rearward marker end of the side marker portion. The towing system may include a plurality of fasteners configured for attaching the integrated mount to an exterior surface of a towed vehicle.

These features and advantages, along with other features and advantages of the present teachings, may be readily apparent from the following detailed description of the modes for carrying out the present teachings when taken in connection with the accompanying drawings. It should be understood that even though the following figures and embodiments may be separately described, single features thereof may be combined to additional embodiments.

### BRIEF DESCRIPTION OF THE DRAWINGS

The accompanying drawings, which may be incorporated into and constitute a part of this specification, illustrate implementations of the disclosure and together with the description, serve to explain the principles of the disclosure.

FIG. 1 illustrates an integrated towing system in accordance with one non-limiting aspect of the present disclosure.

FIG. 2 illustrates a perspective view of a display in accordance with one non-limiting aspect of the present disclosure.

FIG. 3 illustrates a perspective view of an integrated side marker light and wireless camera unit in accordance with one aspect of the present disclosure.

FIG. 4 illustrates an assembly view of the integrated side marker light and wireless camera unit in accordance with one aspect of the present disclosure.

FIG. 5 illustrates a perspective view of an integrated mount with a camera and a side marker light removed in accordance with one aspect of the present disclosure.

FIG. 6 illustrates an inboard side view of the integrated side marker light and wireless camera unit in accordance with one aspect of the present disclosure.

FIG. 7 illustrates an expanded view of the integrated side marker light and wireless camera unit in accordance with one aspect of the present disclosure.

FIG. 8 illustrates a rearward end view of the integrated side marker light and wireless camera unit in accordance with one aspect of the present disclosure.

FIG. 9 illustrates a perspective view of a camera in accordance with one aspect of the present disclosure.

FIG. 10 illustrates a side view of the camera in accordance with one aspect of the present disclosure.

FIG. 11 illustrates a perspective view of an integrated mount with the camera and the side marker light included in accordance with one aspect of the present disclosure.

FIG. 12 illustrates a perspective view of the tear drop camera in accordance with one aspect of the present disclosure.

FIG. 13 illustrates a perspective view of backup camera in accordance with one aspect of the present disclosure.

### DETAILED DESCRIPTION

As required, detailed embodiments of the present disclosure may be disclosed herein; however, it may be understood that the disclosed embodiments may be merely exemplary of the disclosure that may be embodied in various and alternative forms. The figures may not be necessarily to scale; some features may be exaggerated or minimized to show details of particular components. Therefore, specific structural and functional details disclosed herein may need not to be interpreted as limiting, but merely as a representative basis for teaching one skilled in the art to variously employ the present disclosure.

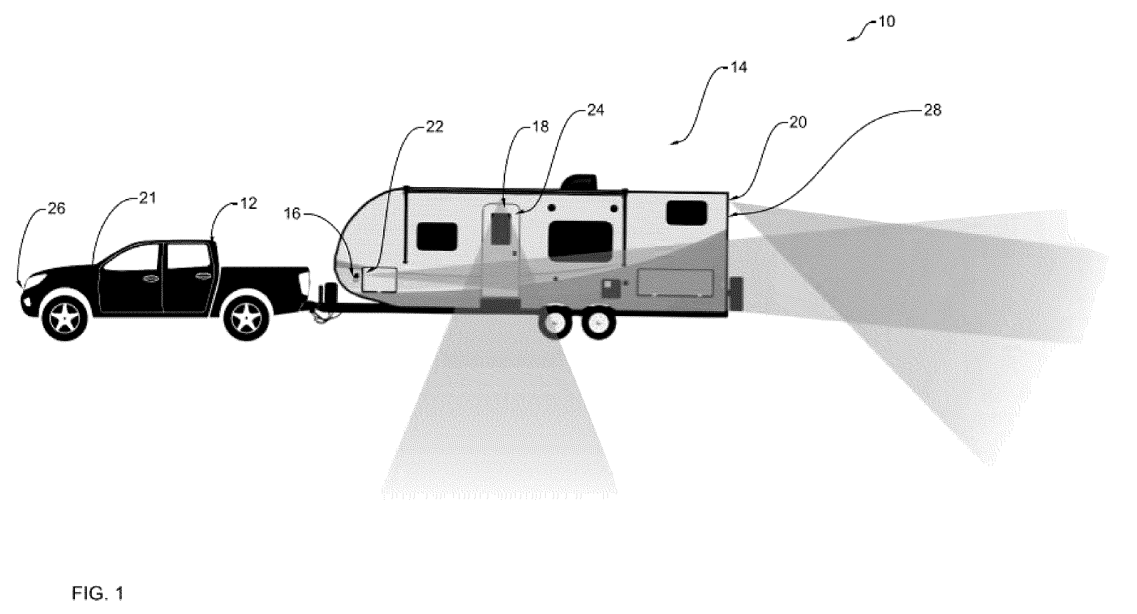

FIG. 1 illustrates an integrated towing system 10 in accordance with one non-limiting aspect of the present disclosure. The towing system 10 is predominately described with respect to a tow vehicle 12 used to tow, trailer, pull, push, or otherwise engage a towed vehicle 14. The tow vehicle 12 may correspond with a truck, car, train, vessel, or other transport capable of generating propulsion suitable for moving or otherwise directing operation of the towed vehicle 14. The tow vehicle 12 is shown with respect to being occupant driven in so far as a driver or other occupant within the vehicle may be responsible for directing vehicle operations, however, the present disclosure fully contemplates the vehicle being autonomously or semi-autonomously driven/controlled. The towed vehicle 14 is shown to correspond with a recreational vehicle (RV), or trailer, connected via a hitch to the tow vehicle 12. This type of towed vehicle 14, likewise, is shown for non-limiting purposes as the towed vehicle 14 may correspond with a wide range of vehicles, vessels, structures, etc. capable of being pushed, pulled, or otherwise directed via the tow vehicle 12. The towed vehicle 14 is predominantly illustrated as an RV due to RVs being one of a wide variety of vehicle types whereby its use may induce blind spots, obstructions, occulted areas, or other concealed zones, which may in turn present difficulties to a driver or a semi-autonomous or autonomous system 10 of the tow vehicle 12.

The towing system 10 may include one or more cameras 16, 18, 20 mounted onboard the towed vehicle 14 to transmit wireless images and/or video to a wireless receiver 21 onboard the towed vehicle 14. The cameras 16, 18, 20 are predominantly described with respect to being wireless cameras capable of wirelessly transmitting captured information, however, the present disclosure fully contemplates the cameras being wired or otherwise relying upon wired communications. The towing system 10 may be operable for providing safety, convenience, and/or otherwise improved towing performance via images collected from one or more wireless cameras 16, 18, 20 strategically placed to capture images of various blind spots, hard to view areas, or other locations around the tow and/or towed vehicles 12, 14 where it may be advantageous to provide visibility. The illustrated scenario includes the towing system 10 having a first wireless camera 16 integrated with a side marker light 22 of the towed vehicle 14, which may be referred to as an integrated side marker light and wireless camera unit 17, a second wireless camera 18 positioned rearward thereof above a side door 24 of the towed vehicle 14, which may be referred to as a tear drop camera 18, and a third wireless camera 20 positioned further rearward above at a rear of the towed vehicle 14, which may be referred to as a backup camera 20. For the sake of presentation simplicity, a front 26 of the tow vehicle 12 may be considered to be a most forward location and a rear 28 of the towed vehicle 14 to be considered to be a most rearward location. A forward direction may correspond with relative directionality towards the front 26, and a rearward direction may correspond with relative directionality towards the rear 28. The illustrated positions of the wireless cameras 16, 18, 20 are shown for non-limiting purposes as the present disclosure fully contemplates the use of more or less wireless cameras 16, 18, 20, including the use of additional wireless cameras that may be attached to the tow vehicle 12 and/or offboard the towed vehicle 14.

The images captured with the wireless cameras 16, 18, 20, which may be still images, static images, video images, or other media, e.g., sound, acoustics, radar, etc., may be wireless transmitted to the wireless receiver 21, which may thereafter integrate the associated images, video, data, positions, etc. derived therefrom with the driver or other entity controlling the tow vehicle 12. For the sake of presentation simplicity, and without limitation, the wireless cameras 16, 18, 20 may be predominately described with respect to generating real-time video, however, the cameras 16, 18, 20 may be used for other purposes, including those associated with collecting other types of data and information. Likewise, the data collected with the wireless cameras 16, 18, 20 may be predominately described with respect to being interfaced with a human occupant tasked with driving the vehicle, i.e., a driver, however, information collected with the wireless cameras may be similarly utilized with autonomous and/or semi-autonomous systems included onboard and/or offboard the tow vehicle 12 and/or with systems onboard the towed vehicle 14, e.g., the towed vehicle 14 may include passengers, control systems, etc., that may similarly benefit from access to information collected with the wireless cameras 16, 18, 20.

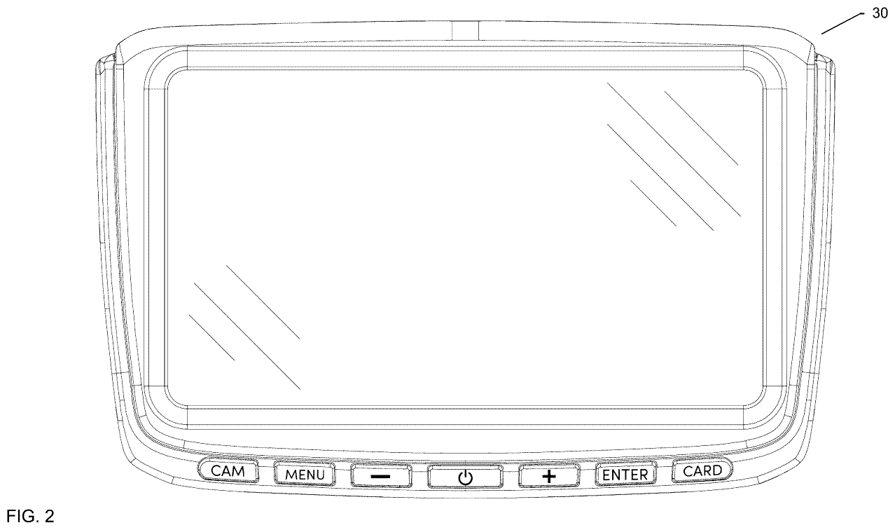

FIG. 2 illustrates a perspective view of a display 30 that may be included inside of the vehicle to act as a human-machine interface (HMI) operable for interfacing the wireless cameras 16, 18, 20 with the driver. The display 30 may include the wireless receiver 21 and/or otherwise be in communication therewith. The display 30 may be considered as a monitor or other device, which may be constructed out of polished and/or textured plastic, optionally with a front face design that has strongly defined edges to give the unit 17 a modern aesthetic and function as a signifier in the user's hands. The buttons may be nested within a bottom recess of the frame to make it easier for the user to feel and click on the desired button, optionally with the buttons illuminating blue colored light in dark instances. The rear right side of the display 30 may include a notch for an SD Card to sit in, completely flush to the side of the display 30. The rear left side of the monitor may include a hole for an antenna to be installed for wireless applications. The rear top corners of the monitor may include vents to cool down the monitor and allow sound from the speaker to escape the housing. Additionally, on the rear side of the monitor, a central exit for a monitor power cable may be included in order to route the power cord along a desired mounting solution. The display 30 may employ a mounting system configured to fit universally on vehicles dashboards, optionally in an area where it is made possible for the driver to see clearly. The mounting may be fulfilled by an integrated finished black steel bracket on the back of the monitor with a slot and threaded hole. The slot and hole may allow the installation for a variety of mounting attachments that may be preferred by the user's given application. The display 30 may introduce key features on the buttons to enhance the user experience and convenience. The seven buttons on the monitor may include specific functions when clicked and may be placed in a specific order for a better user experience. These buttons may include CAM, MENU, −, +, ENTER, CARD, with the attendant button functions including: CAM: change camera, hold down to pair to camera; MENU: open menu, back; −: decrease brightness on CAM screen to move selection left; : Screen on/off; +: Increase brightness on CAM screen; ENTER: select; and CARD: open SD Card menu.

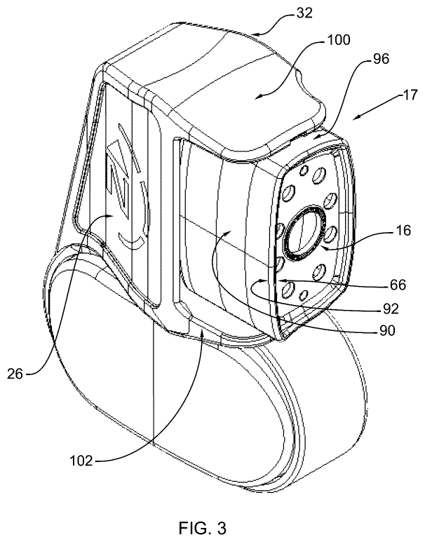

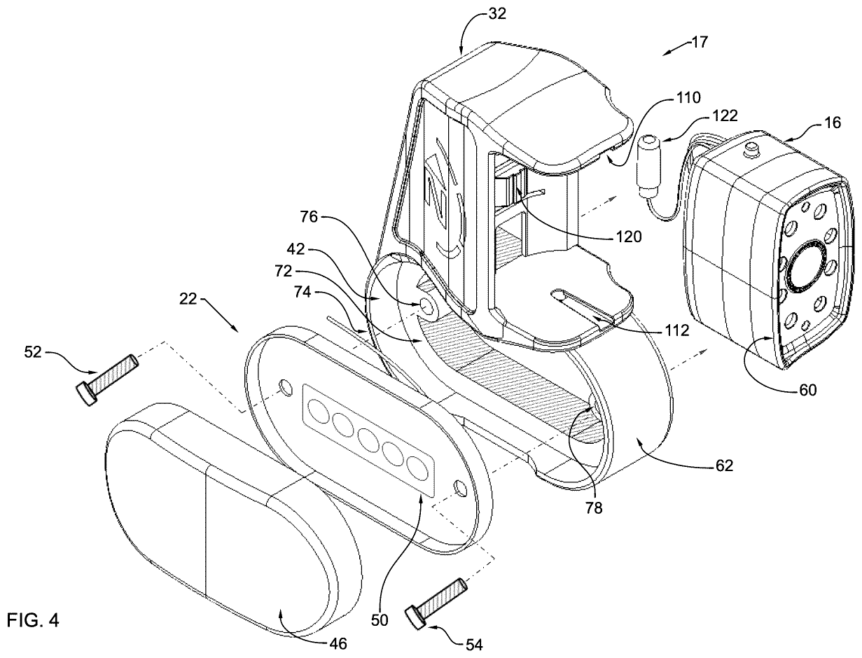

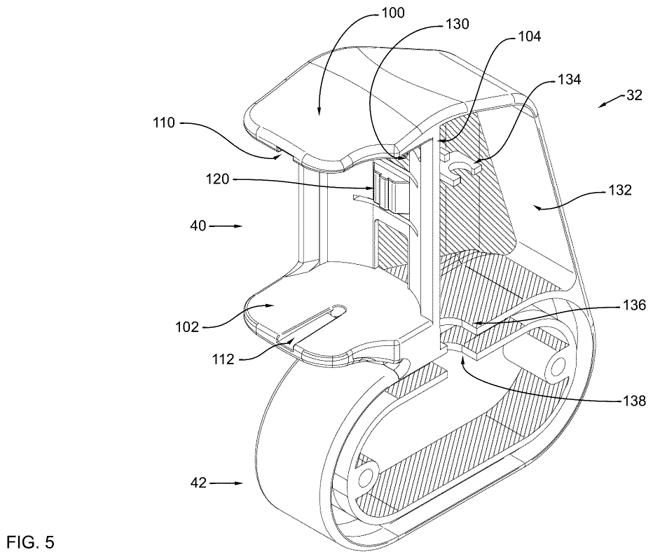

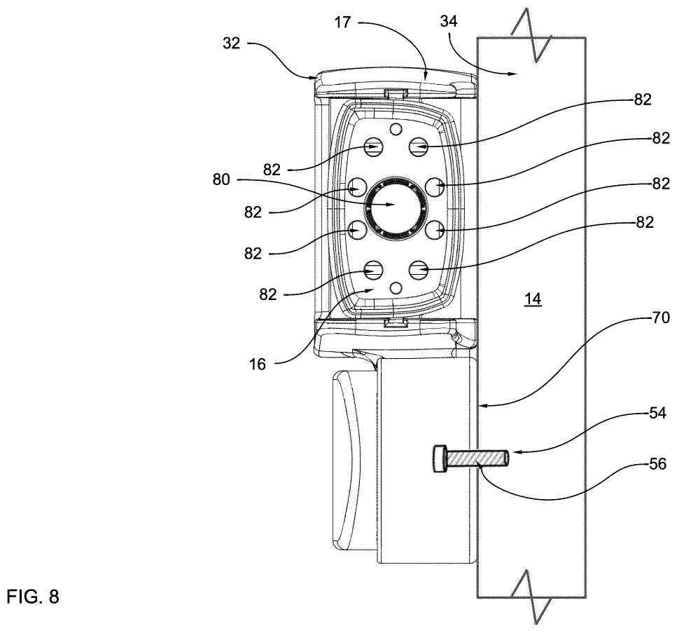

FIG. 3 illustrates a perspective view of the integrated side marker light and wireless camera unit 17 in accordance with one aspect of the present disclosure. The unit 17 may include an integrated mount 32 configured for mounting the side marker light 22 and the wireless camera 16 to an exterior surface 34 of the towed vehicle 14. FIG. 4 illustrates an assembly view of the unit 17 in accordance with one aspect of the present disclosure. FIG. 5 illustrates a perspective view of the integrated mount 32, with the camera 16 and the side marker light 22 removed. As shown in FIG. 4, the integrated mount 32 may include a camera portion 40 for retaining the wireless camera and a side marker portion 42 for retaining the side marker light 22 in such a way that the integrated mount 32 may be attached to the towed vehicle 14 by simply separating a light lens 46 from a light source frame 48 mounted to a light source 50 of the side marker light 22, removing fasteners 52, 54 used to attaching the light source frame 48 to an exterior of the towed vehicle 14, inserting the light source frame 48 and the wireless camera 16 into the integrated mount 32, and fastening the integrated mount 32 to the location previously used for the side marker light 22 through re-use of the fasteners 52, 54, or other suitable fasteners, and thereafter reattaching the light lens 46 to the light source frame 48, such as with a snap fit. In this manner, the integrated mount 32 may optionally be configured to leverage use of fasteners, supports, electrical connections, drill holes, etc. employed to attach the side marker light 22 at the time of manufacture. The integrated mount 32 may optionally be attached to the towed vehicle 14 without having to drill additional holes and/or otherwise undertake complex installation, i.e., by using the same two holes 56 (see FIG. 8) included at the time of manufacture for the side marker light 22, while at the same time optionally minimizing costs by enabling re-use of a previously installed equipment, apertures, framing, etc.

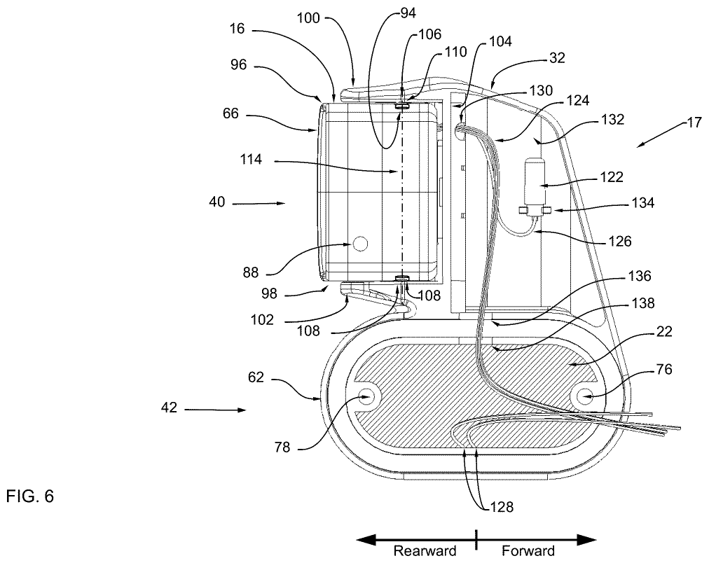

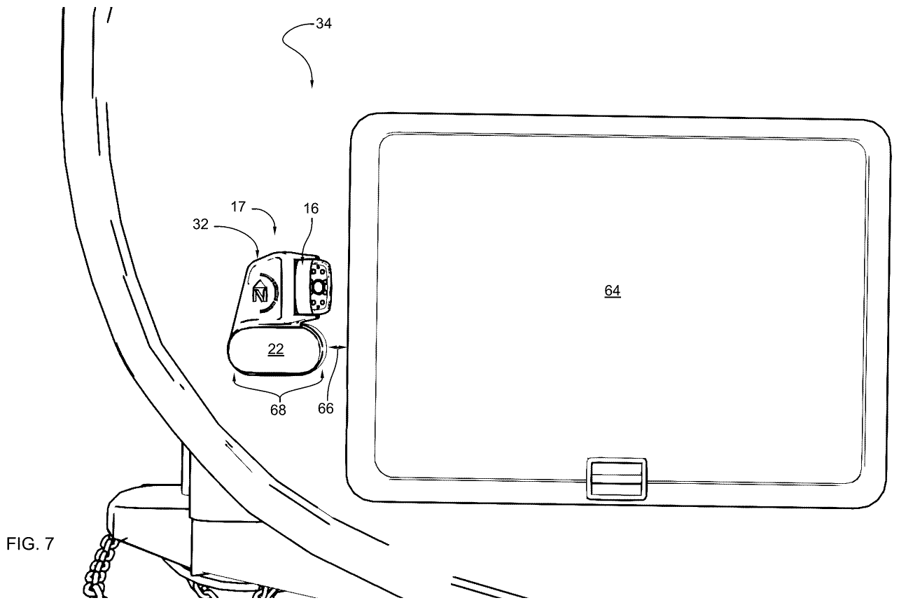

The side marker portion 42 and the camera portion 40 may be configured to vertically orientate the camera 16 relative to the side marker light 22. One aspect of the present disclosure includes the camera 16 being mounted above the side marker light 22 and the integrated mount 32 shaped such that a rearward camera end 60 of the camera 16 may be flush with or forward of a rearward marker end 62 of the side marker portion 42. FIG. 6 illustrates an inboard side view of the integrated side marker light and wireless camera unit 17 in accordance with one aspect of the present disclosure. As shown, the rearward camera end 60, i.e., the most rearward edge of the camera 16, may be approximately flush with the rearward marker end 62 of the side marker portion 42, i.e., the most rearward edge of the integrated mount 32. FIG. 7 illustrates an expanded view of the integrated side marker light and wireless camera unit 17 in accordance with one aspect of the present disclosure. As shown, the flush or nearly flush relationship between the camera 16 and the side marker portion 42 may be advantageous in allowing the integrated mount 32 to be used in mounting the camera 16 in close proximity to a door, an opening, a panel, or other access point 64 included on the towed vehicle 14 without obstructing the use thereof. The integrated mount 32, in other words, may be used to mount the camera 16 using existing infrastructure for the side marker light 22 while at the same time doing so without interfering with the use of an adjoining access point 64, i.e., the camera 16 may be positioned without overlapping important features of the towed vehicle 14. A gap 66 between the side marker light 22 and the access point 64 may be narrower than a width 68 of the camera 16 such that reconfiguring the integrated mount 32 to laterally mount the camera 16, i.e., in a non-flush arrangement off to the side of the side marker light 22, may result in the camera 16 obstructing the access point 64.

The integrated camera 16 mount is shown to position the camera 16 above the side marker light 22 for non-limiting purposes as the present disclosure fully contemplates reconfiguring the integrated mount 32 to position the camera 16 below the side marker light 22 and/or on a forward side, i.e., on the side opposite to the access point 64. Utilizing the integrated mount 32 to mount the camera 16 on the forward side of the side marker light 22 may be less beneficial than the illustrated embodiment due to the camera 16 potentially blocking light emitted from the side marker light 22 in a forward direction. Likewise, if the camera 16 were mounted below the side marker light 22, that too may obstruct light emitted from the side marker light 22 in a downward direction. While positioning the camera 16 above the side marker light 22 may partially obstruct light emitted from the side marker light 22 in an upward direction, that obstruction may be less detrimental and less important to roadway safety. The illustrated positioning of the unit 17 on a left-hand side of the towed vehicle 14 is shown for non-limiting purposes as the unit 17 may be similarly positioned on a right side of the vehicle. A mirrored version or inverse of the illustrated integrated mount 32 (not shown) may be employed to facilitate similarly mounting the camera 16 to the other side of the towed vehicle 14, i.e., using an existing side marker light 22 with the camera 16 mounted above in a flush relationship.

As shown in FIG. 6, the flush relationship between the rearward camera end 60 and the rearward marker end 62 is believed to provide an aesthetically pleasing relationship. The present disclosure, however, fully contemplates other spatial relationships between the camera 16 and the side marker, including a non-flush relationship whereby the camera 16 may be positioned forward of or offset from side marker light 22, i.e., the rearward camera end 60 may be slightly forward of the rearward marker end 62. FIG. 8 illustrates a schematic, end view of the unit 17 when mounted in accordance with one aspect of the present disclosure. As shown, an inboard or inner side 70 of the integrated mount 32, i.e., the side closest to the exterior surface 34 of the towed vehicle 14, may be shaped such that the integrated mount 32 presses against or is flush with the exterior surface 34. The fasteners 52, 54 shown in FIG. 4 may be threaded fasteners or the like capable of generating a compressive fit by pressing the light source frame 48 against an inner support ledge 72 inboard of an outboard or outer side 74 of the side marker portion 42. The fasteners 52, 54 may thereafter extend through a corresponding one of a plurality of through-holes 76, 78 configured for passing the fasteners 52, 54 from the light source frame 48 through the side marker portion 42 to the exterior surface 34. Thereafter, the holes 56 previously drilled for the side marker light 22 may be reused. The present disclosure fully contemplates the use of a wide variety fasteners and features for attaching the integrated mount 32 to the towed vehicle 14, including the use of newly drilled holes and/or additional/other attachment features, e.g., magnets, adhesives, clips, etc.

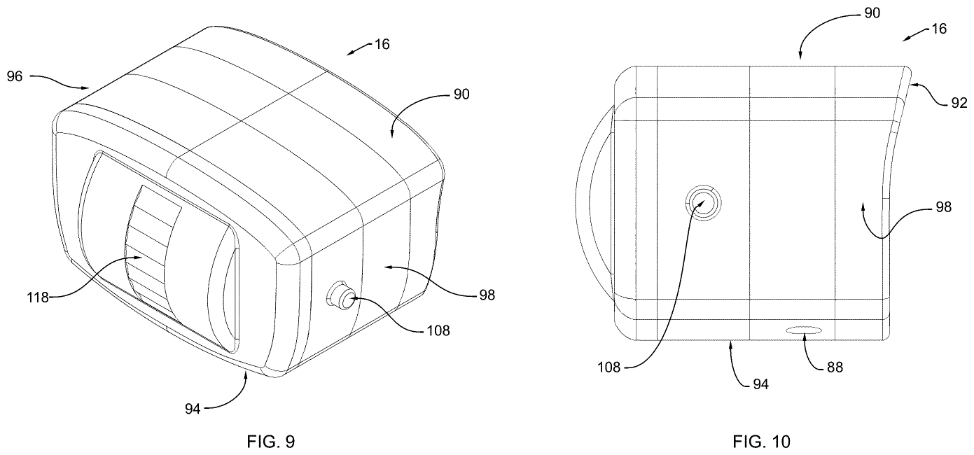

As shown in FIG. 8, once attached to the towed vehicle 14, the integrated mount 32 may be configured to permit the camera 16 to be rotated or turned side-to-side, or more specifically, to allow a camera lens 80 to be directed towards a targeted area. The capability to articulate the camera 16 may be beneficial in enable a user to adjust the camera's field of view according to their particular needs, e.g., this flexibility may be helpful in allowing adjustments to account for anatomically differences between drivers causing one driver to view a blind spot differently than another driver. The camera lens 80 is shown to be approximately in the middle of the camera 16 at a centralized location and surround by eight infrared emitters 82 configured for providing superior night visibility. The camera 16 may also include a light sensor 84 to intelligently and automatically control camera 16 operation, e.g., a controller (not shown) or other feature of the camera 16 may use the light sensors to shift a filter as function of current lighting conditions. A light emitting diode (LED) 86 or other HMI may be include to indicate operational states for the camera 16. FIG. 9 illustrates a perspective view of the camera 16 in accordance with one aspect of the present disclosure. FIG. 10 illustrates a side view of the camera 16 in accordance with one aspect of the present disclosure. A pairing button 88 may be included to facilitate manual pairing between the camera 16 and the monitor 30, which may be beneficial in simplifying the installation process and facilitating quick and efficient pairing. The led 86 may be included to provide a clear visual indication of the camera's power status, ensuring a reliable connection and assisting the pairing process.

An outboard lateral side 90 of the camera 16 may include a sun visor 92 extending rearwardly beyond the camera 16 lens to provide an overhang operable for shading the camera 16 lens. Turning to FIG. 3, a rearward portion 66 of the sun visor may define the rearward camera end 60, i.e., the most rearward part of the camera 16 that is to be posited flush with or forward of the rearward marker end 62. The camera 16 may include an inboard lateral side 94, an upper medial side 96, and a lower medial side 98 of the camera 16 forward of the rearward camera end 60. Turning to FIG. 6, the camera 16 portion 40 may include an upper medial arm 100 and a lower medial arm 102 extending rearwardly relative to a vertical divider 104. The upper medial arm 100 may be configured to extend partially over the upper medial side 96 and the lower medial arm 102 may be configured to extend partially over the lower medial side 98. The upper medial side 96 may include an upper protrusion 106, the lower medial side 98 may include a lower protrusion 108, the upper medial arm 100 may include an upper recess 110 configured for pivotably retaining the upper protrusion 106, and the lower medial arm 102 may include a lower recess 112 configured for pivotably retaining the lower protrusion 108. The upper and lower protrusions 106, 108 may cooperate with the upper and lower recesses 110, 112 to permit the camera 16 to be concentrically rotated relative to an axis 114 extending through the upper and lower protrusions 106, 108.

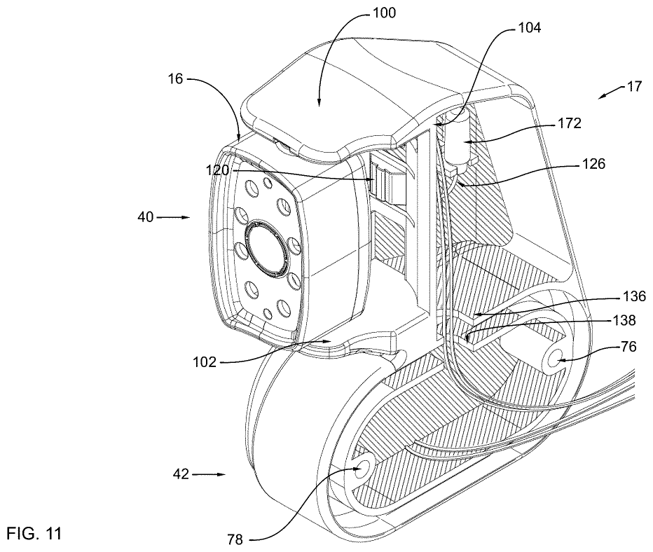

The upper and lower medial arms 100, 102 may be shorter widthwise than the upper and lower medial sides 96, 98 to facilitate installation and to permit maximum rotation of the camera 16. As shown in FIG. 9, the camera 16 may include an arcuate forward surface having a plurality of recesses 118. As shown in FIG. 4, the recesses 118 may be operable for engaging an arcuate central surface of the vertical divider having a plurality of retention 120 elements such that the retention elements 120 may be configured for releasably engaging with the recesses 118 to provide a snap fit suitable for allowing the camera 16 to be rotated and thereafter retained in place. Returning to FIG. 6, the controller or other element included inside of the camera 16 to control its operable may include a wireless transmitter (not shown) or other feature to facilitate wireless transmission of the video. The wireless transmitter may utilize an antenna 122 to facilitate transmitting video and/or other information captured with the camera 16 or otherwise needed for wireless exchange therewith, e.g., data used for pairing or other types of communication. As shown in the perspective view of FIG. 11, the camera 16 may include a plurality of camera power cables 124 configured for electrically connecting a controller of the wireless camera 16 to an electrical system (not shown) of the towed vehicle 14 and an antenna cable 126 configured for connecting the antenna 122 to the wireless transmitter, i.e., controller or other feature of camera 16. The side marker light 22 may include a plurality of side marker power cables 128 configured for electrically connecting the light source to the electrical system.

The power cables 124, 128 may be tied together, such as with a wire nut, to facilitate commonly connecting to the electrical system of the towed vehicle 14. The electrical system, for example, may be lower voltage, direct current (DC) type of bus, e.g., 4-16 VDC. The electrical system may be configured at the time of manufacture to power the side marker light 22, such as with a constant current supply sufficient for driving light emitting diodes or other type of device operable for emitting light towards the light lens 46, which the light lens 46 may then disperse to illuminate an ambient area. The electrical system may be configured to operate the side marker light 22 as running lights, such as by constantly powering the side marker light 22 to illuminate while the towed vehicle 14 is in use or connected to the tow vehicle 12 while powered. By tying the camera 16 power into the same electrical system and/or by using the same supply of constant power, the camera 16, likewise, may be powered when the side marker light 22 is powered. This may be advantageous in allowing the camera 16 to operate without having to alter the electrical system, i.e., the camera 16 may be operational using what was intended at the time of manufacture for powering the side marker light 22. Use of the existing, electrical system of the towed vehicle 14 to power both of the camera 16 and the side marker light 22 is noted for non-limiting purposes as the present disclosure fully contemplates connecting the camera 16 to other and/or additional power sources, e.g., a solar source, battery, and/or another circuit.

The vertical divider 104 may include a vertical opening 130 configured to define a vertical passageway for the camera power cables 124 and the antenna cable to pass through the vertical divider 104 to an antenna enclosure 132. The antenna enclosure 132 may be a part of the camera portion 40 extending forwardly relative to the vertical divider 104 and configured for concealing the antenna 122 from external view. The antenna enclosure 132 may include an antenna holder 134 configured for snap fitting and retaining the antenna 122. A lower side of the camera portion 40 may include a lower horizontal opening 136 to define a lower horizontal passageway for the camera power cables 124. An upper side of the side marker portion 42 may include an upper horizontal opening 138 aligned with the lower horizontal opening to define an upper horizontal passageway for the camera power cables 124 to pass through to an interior of the side marker portion 42. In this manner, the camera and side marker power cables 124, 128 may be directed to a common location or in proximity to each other, optionally so that the cables 124, 128 may thereafter be fed together through a common opening or connection (not shown) to the electrical system of the towed vehicle 14. The side marker portion 42 may optionally include a seal, gasket, etc. (not shown) to seal or press against the exterior surface 34 of the tow vehicle 12, which when coupled with the camera and side marker power lines 124, 128 commonly terminating relative to the side marker light 22, may provide an aesthetically please appearance, i.e., the power and antenna cables 124, 128 and the antenna 122 may be concealed from external view.

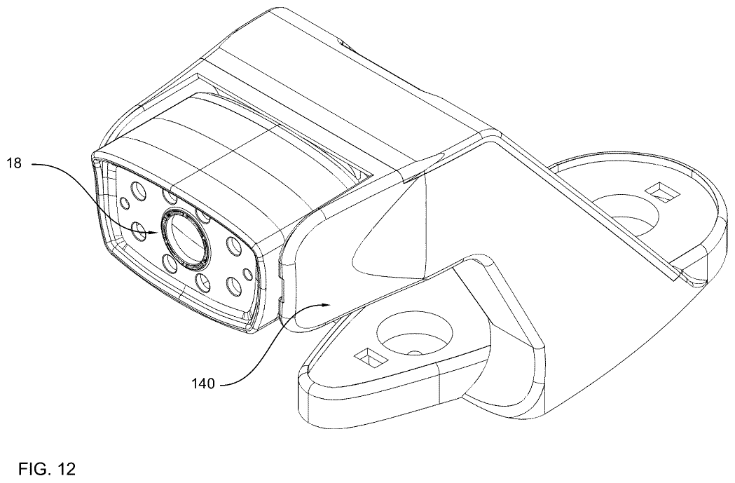

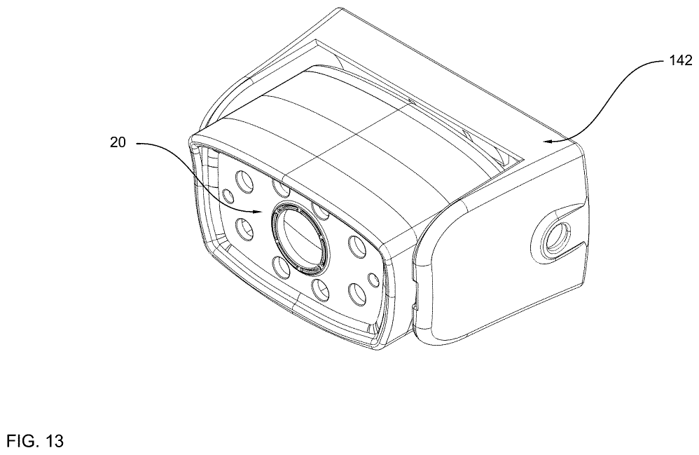

FIG. 12 illustrates a perspective view of the tear drop camera having a tear drop mount 140 in accordance with one aspect of the present disclosure. FIG. 13 illustrates a perspective view of backup camera 20 having a backup mount 142 in accordance with one aspect of the present disclosure.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. An integrated side marker light and wireless camera unit, comprising:
a side marker light including a light source and a light lens, wherein the light source is configured for emitting light towards the light lens and the light lens is configured for dispersing the light to illuminate an ambient area;
a camera including a camera lens and a wireless transmitter, wherein the camera lens is configured for generating video images and the wireless transmitter is configured for wirelessly transmitting the video images to a wireless receiver of a tow vehicle; and
an integrated mount configured for retaining the side marker light and the camera to an exterior surface of a towed vehicle, wherein the integrated mount includes a side marker portion configured for retaining the side marker light and a camera portion configured for retaining the camera, wherein the side marker portion and the camera portion are configured to vertically orientate the camera relative to the side marker light such that a rearward camera end of the camera is flush with or forward of a rearward marker end of the side marker portion.

2. The integrated side marker light and wireless camera unit of claim 1, wherein:
the side marker portion and the camera portion are shaped to orientate the camera above the side marker light.

3. The integrated side marker light and wireless camera unit of claim 1, wherein:
an outboard lateral side of the camera includes a sun visor extending rearwardly beyond the camera lens to provide an overhang operable for shading the camera lens, wherein a rearward portion of the sun visor defines the rearward camera end.

4. The integrated side marker light and wireless camera unit of claim 3, wherein:
an inboard lateral side, an upper medial side, and a lower medial side of the camera are forward of the rearward camera end.

5. The integrated side marker light and wireless camera unit of claim 4, wherein:
the camera portion includes an upper medial arm and a lower medial arm extending rearwardly relative to a vertical divider, wherein the upper medial arm is configured to extend partially over the upper medial side and the lower medial arm is configured to extend partially over the lower medial side.

6. The integrated side marker light and wireless camera unit of claim 5, wherein:
the upper medial side includes an upper protrusion;
the lower medial side includes a lower protrusion;
the upper medial arm includes an upper recess configured for pivotably retaining the upper protrusion;
the lower medial arm includes a lower recess configured for pivotably retaining the lower protrusion; and
the upper and lower protrusions cooperate with the upper and lower recesses to permit the camera to be concentrically rotated relative to an axis extending through the upper and lower protrusions.

7. The integrated side marker light and wireless camera unit of claim 6, wherein:
the upper and lower medial arms are shorter widthwise than the upper and lower medial sides.

8. The integrated side marker light and wireless camera unit of claim 6, wherein:
an arcuate forward surface of the camera includes a plurality of recesses; and
an arcuate central surface of the vertical divider includes a plurality of retention elements configured for releasably engaging with the recesses to provide a snap fit therewith.

9. The integrated side marker light and wireless camera unit of claim 8, wherein:
the wireless transmitter includes an antenna; and
the camera portion includes an antenna enclosure extending forwardly relative to the vertical divider, wherein the antenna enclosure is configured for concealing the antenna from external view.

10. The integrated side marker light and wireless camera unit of claim 9, wherein:
the antenna enclosure includes an antenna holder configured for snap fitting and retaining the antenna.

11. The integrated side marker light and wireless camera unit of claim 9, wherein:
the light source is mounted to a light source frame, wherein the light source framed is configured to removably snap fit with the light lens and includes a plurality of apertures, wherein each aperture is configured for receiving one of a plurality of fasteners configured to retain the integrated mount against the exterior surface.

12. The integrated side marker light and wireless camera unit of claim 11, wherein:
the side marker portion includes an inner support ledge configured for supporting the side marker light, wherein the inner support ledge in inboard of an outer side of the side marker portion and includes a plurality of through-holes configured for passing the fasteners from the light source frame through the side marker portion to the exterior surface.

13. An integrated mount configured for attaching a side marker light and a wireless camera to an exterior surface of a towed vehicle with a plurality of fasteners, comprising:
a camera portion configured for retaining the wireless camera, wherein the wireless camera includes a camera lens configured for generating video images and a wireless transmitter configured for wirelessly transmitting the video images to a wireless receiver of a tow vehicle;
a side marker portion configured for retaining the side marker light, wherein the side marker light includes a light source configured for emitting light and a light lens configured for dispersing the light to illuminate an ambient area, wherein a light source frame is attached to the light source and includes a plurality of apertures configured for receiving a corresponding one of the fasteners;
wherein the side marker portion includes a plurality of through-holes, wherein each through-hole is aligned with one of the apertures to permit the fastener received therein to pass through the side marker portion to the exterior surface; and
wherein the side marker portion and the camera portion are configured to vertically orientate the wireless camera relative to the side marker light such that a rearward camera end of the wireless camera is flush with or forward of a rearward marker end of the side marker portion.

14. The integrated mount of claim 13, wherein:
the wireless camera includes an outboard lateral side, an inboard lateral side, an upper medial side, and a lower medial side; and
the camera portion includes an upper medial arm and a lower medial arm extending rearwardly relative to a vertical divider, wherein the upper medial arm is configured to extend partially over the upper medial side and the lower medial arm is configured to extend partially over the lower medial side.

15. The integrated mount of claim 14, wherein:
the upper medial side includes an upper protrusion;
the lower medial side includes a lower protrusion;
the upper medial arm includes an upper recess configured for pivotably retaining the upper protrusion;
the lower medial arm includes a lower recess configured for pivotably retaining the lower protrusion; and
the upper and lower protrusions cooperate with the upper and lower recesses to permit the camera to concentrically rotate relative to an axis extending through the upper and lower protrusions.

16. The integrated mount of claim 15, wherein:
the wireless transmitter includes an antenna; and
the camera portion includes an antenna enclosure extending forwardly relative to the vertical divider, wherein the antenna enclosure is configured for concealing the antenna from external view.

17. The integrated mount of claim 16, wherein:
the wireless camera includes a plurality of camera power cables and an antenna cable, wherein the camera power cables are configured for electrically connecting a controller of the wireless camera to an electrical system of the towed vehicle and the antenna cable is configured for connecting the antenna to the controller;
the side marker light includes a plurality of side marker power cables configured for electrically connecting the light source to the electrical system;
the vertical divider includes a vertical opening configured to define a vertical passageway for the camera power cables and the antenna cable to pass through the vertical divider;
a lower side of the camera portion includes a lower horizontal opening to define a lower horizontal passageway for the camera power cables and the antenna cable; and
an upper side of the side marker portion includes an upper horizontal opening aligned with the lower horizontal opening to define an upper horizontal passageway for the camera power cables and the antenna cable to pass through to an interior of the side marker portion.

18. An integrated towing system, comprising:
a side marker light including a light source and a light lens, wherein the light source is configured for emitting light towards the light lens and the light lens is configured for dispersing the light to illuminate an ambient area;
a camera including a camera lens and a wireless transmitter, wherein the camera lens is configured for generating video images and the wireless transmitter is configured for wirelessly transmitting the video images;
a wireless receiver configured for use in a tow vehicle to wirelessly receive and display the video images;
an integrated mount configured for retaining the side marker light and the camera, wherein the integrated mount includes a side marker portion configured for retaining the side marker light and a camera portion configured for retaining the camera, wherein the side marker portion and the camera portion are configured to vertically orientate the camera relative to the side marker light such that a rearward camera end of the camera is flush with or forward of a rearward marker end of the side marker portion; and
a plurality of fasteners configured for attaching the integrated mount to an exterior surface of a towed vehicle.

19. The integrated towing system of claim 18, wherein:
the side marker light includes a light source frame, wherein the light source frame is attached to the light source and includes a plurality of apertures configured for receiving a corresponding one of the fasteners; and
wherein the side marker portion includes a plurality of through-holes, wherein each through-hole is aligned with one of the apertures to permit the fastener received therein to pass through the side marker portion.

20. The integrated towing system of claim 19, wherein:
the wireless camera includes an outboard lateral side, an inboard lateral side, an upper medial side having an upper protrusion, and a lower medial side having a lower protrusion;
the camera portion includes an upper medial arm and a lower medial arm extending rearwardly relative to a vertical divider, wherein the upper medial arm includes an upper recess configured for pivotably retaining the upper protrusion and the lower medial arm includes a lower recess configured for pivotably retaining the lower protrusion;
the upper and lower protrusions cooperate with the upper and lower recesses to permit the camera to concentrically rotate relative to an axis extending through the upper and lower protrusions;
the camera portion includes an antenna enclosure extending forwardly relative to the vertical divider, wherein the antenna enclosure is configured for concealing an antenna connected to the wireless transmitter from external view
the wireless camera includes a plurality of camera power cables and an antenna cable, wherein the camera power cables are configured for electrically connecting a controller of the wireless camera to an electrical system of the towed vehicle and the antenna cable is configured for connecting the antenna to the controller;
the side marker light includes a plurality of side marker power cables configured for electrically connecting the light source to the electrical system;
the vertical divider includes a vertical opening configured to define a vertical passageway for the camera power cables and the antenna cable to pass through the vertical divider;
a lower side of the camera portion includes a lower horizontal opening to define a lower horizontal passageway for the camera power cables and the antenna cable; and
an upper side of the side marker portion includes an upper horizontal opening aligned with the lower horizontal opening to define an upper horizontal passageway for the camera power cables and the antenna cable to pass through to an interior of the side marker portion.
